(19) United States
(12) Patent Application Publication
(10) Pub. No.: US 2006/0213899 A1
(43) Pub. Date: Sep. 28, 2006

(54) Heater and temperature measurement system

(75) Inventors: Ronald A. Outlaw, Williamsburg, VA (US); Brian C. Holloway, Williamsburg, VA (US)

Correspondence Address: WILLIAM AND MARY TECHNOLOGY TRANSFER OFFICE, 402 JAMESTOWN RD, PO BO 8795, WILLIAMSBURG, VA, 23187-8795, US

(73) Assignee: College of William and Mary

(21) Appl. No.: 11/288,678

(22) Filed: Nov. 29, 2005

Related U.S. Application Data
(60) Provisional application No. 60/631,441, filed on Nov. 29, 2004.

(51) Int. Cl. F27B 14/00

(52) U.S. Cl. 219/425

(57) ABSTRACT

Current industrial and research applications that utilize resistance heating and temperature measurement require separate power and temperature connections, typically two for each. Such applications require separate assemblies and control. We describe herein a combined unit utilizing a thermocouple wire as one of its two leads. The resulting device requires only two connections and one control. An alternating cycle can be used to apply heating power, and temperature measurements are made during the power off portion of the cycle.

### CROSS-REFERENCE TO RELATED APPLICATIONS

This application is based upon and claims priority to U.S. Provisional Patent Application No. 60/631,441, filed Nov. 29, 2004, the contents of which are incorporated by reference in their entirety.

### STATEMENT REGARDING FEDERALLY SPONSORED RESEARCH OR DEVELOPMENT

This invention was made with U.S. Government support under grant N00014-02-1-0711 awarded by the Office of Naval Research. The U.S. Government may have certain rights in this invention.

### BACKGROUND OF THE INVENTION

Resistance heating (passage of current through a high resistance wire to generate a high I²R loss in the form of heat) is a commonly used method for raising the temperature of devices in many different technologies, e.g., various electric heaters, samples, substrates, molds, injection mold guns, chambers, stages, and platens. In these applications, a separate device from the heater is usually required for measurement of the temperature (e.g., thermocouples, thermistors, pyrometers). In temperature-controlled units, a feedback circuit from the sensor is used to control the input power so as to achieve a desired temperature set point. Therefore, a heater assembly usually consists of the following components: a specific heater that is selected for the application, heater control, temperature sensor and electronics, and feedback circuitry. In addition to the expense of these individual components and the space required to accommodate the additional apparatus, spatial problems with a separate thermocouple or temperature measurement may occur in the application. This is particularly common and problematic in small, complex, and crowded regions.

For example, in temperature desorption spectroscopy, when testing is conducted under vacuum that requires heating, contact between a thermocouple and the sample may be difficult. It is desirable to only capture the gas coming off the surface; therefore, the heater should have a small thermal mass to allow for the predominant signal to, come from the sample.

The current state-of-the-art is a “button” heater. The deficiency in the button heater is that it does not have a thermocouple. Accordingly, complex electronics are required, with corresponding high costs. One solution, described herein, is to make the heater and temperature sensor the same device.

In pending United States Patent Application No. 2005/0109767, Fennewald et al. use this integrated approach to describe a layered heater comprising a resistive layer that is both a heater element and a temperature sensor. This is very useful for providing average temperatures, but not multiple point temperatures within a given area.

### BRIEF SUMMARY OF THE INVENTION

We have produced a resistance heater made of selected high-resistance thermocouple elements wherein the junction is located at a strategic position of interest for temperature measurement. An alternating cycle (e.g., a square wave pattern) can be used such that the device operates in the heating mode when the high current power is applied and operates in the temperature measurement mode during power off periods. The power off mode may require some time to settle out (because the square wave is not perfectly square in practice), and then the thermocouple (TC) voltage is detected and measured. Ideally, the control circuitry employs a relatively noise-free power off to maximize sensitivity of temperature detection.

In one embodiment, the invention is a thin-sheet heater with a thermocouple wire as one of the two leads. The invention allows for a time-controlled power supply/heater and voltmeter all within the leads. This device uses the same lead for heat and temperature control, thereby allowing simple electronics and a low-cost electrical feed through to a vacuum system.

In other embodiments, devices of the present invention can be incorporated into injection mold guns at multiple places, including the exit aperture. Other devices of the present invention can be used to facilitate and monitor thin film deposition.

The temperature range of the device is determined by the materials used. The methods and devices of the present invention can be used with any resistance heater/thermocouple material, but must be compatible with the environment and the temperature range required.

### BRIEF DESCRIPTION OF THE DRAWINGS

The accompanying drawings illustrate a complete embodiment of the invention according to the best modes so far devised for the practical applications.

FIG. 1 is a diagram of a square wave.

FIG. 2 shows a schematic diagram of one embodiment of the invention, a sample holder for temperature desorption spectroscopy.

FIG. 3 shows a schematic of one embodiment of the invention, an integral temperature measurement and resistance heater positioned at the tip of an injection mold gun.

FIG. 4 is a detailed circuit diagram for an integral temperature measurement and resistance heater.

FIG. 5 shows a detailed engineering diagram of a heater/thermocouple of the present invention.

### DETAILED DESCRIPTION OF THE INVENTION

As used herein, the term “alternating cycle” refers to a regular pulse pattern wherein power is alternately turned on and off. A square wave is one form of alternating cycle. In a theoretically ideal square wave, the duty cycle (i.e., the ratio of the pulse duration to the pulse period) is 0.5. Square waves are frequently imperfect. In some embodiments of the invention, it may be useful to have rectangular wave patterns, with duty cycles in the range 0.1 to 0.9.

Industrial and research applications employing resistance heating and temperature measurement previously required separate power and temperature connections (usually two for each). Such applications required separate assemblies and control. We have developed and successfully tested a combined unit that requires only two connections and one control. This system utilizes an alternating cycle to apply heating power. During the power off portion of the cycle, temperature is measured. A prototypical heater of the present invention is capable of heating to over 1200 degrees Celsius, with accurate temperature measurements obtained simultaneously (Table 1 and Table 2). The design also permits integral temperature control of the heater for special thermal programs.

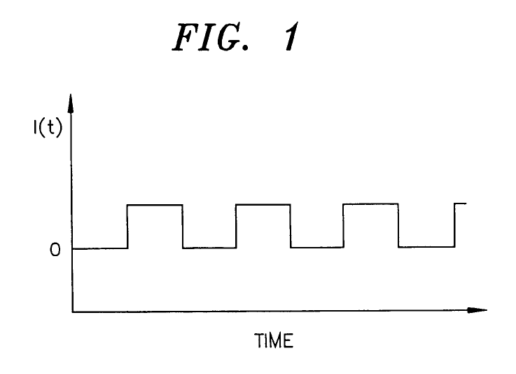

Referring now to the drawings, FIG. 1 is a diagram of a square wave. The heater/temperature measurement device works in the heating mode when high current power is applied, and in the temperature measurement mode during power off periods (corresponding to a value of 0 on the y-axis of FIG. 1).

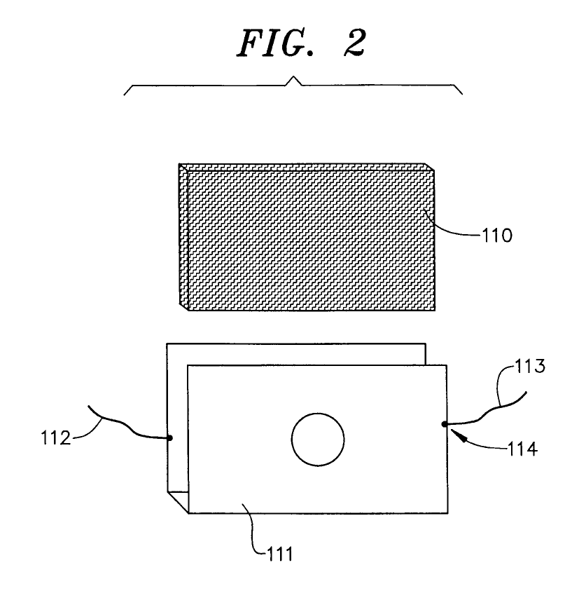

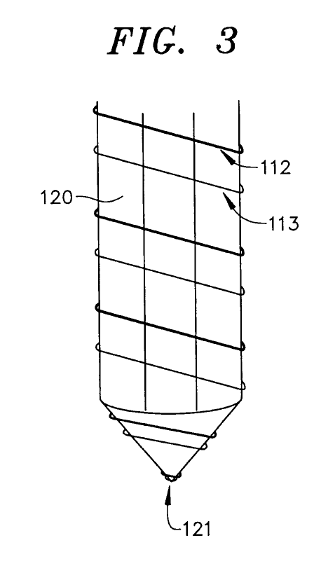

FIGS. 2 and 3 show typical examples of representative devices of the invention using R/X type thermocouple wire. In FIG. 2, the Pt wire 112 and PtRh wire 113 are used as the heater and the Pt envelope 111 is used to hold a sample 110 which is contained in a virtual black body. The junction 114 is where the PtRh heater wire 113 is spot welded to the Pt envelope 111. This is an ideal method for heating samples in diagnostic systems that require either vacuum or operate in a specific gas environment. In FIG. 3, the heater assembly comprises Pt wire 112 and PtRh wire 113 encapsulated in a sleeve with ceramic insulation that is helically wrapped around an injection mold gun 120. The junction is located at the gun's tip 121 (the exit aperture). Variations on the heater assembly allow measurement over the length of the gun.

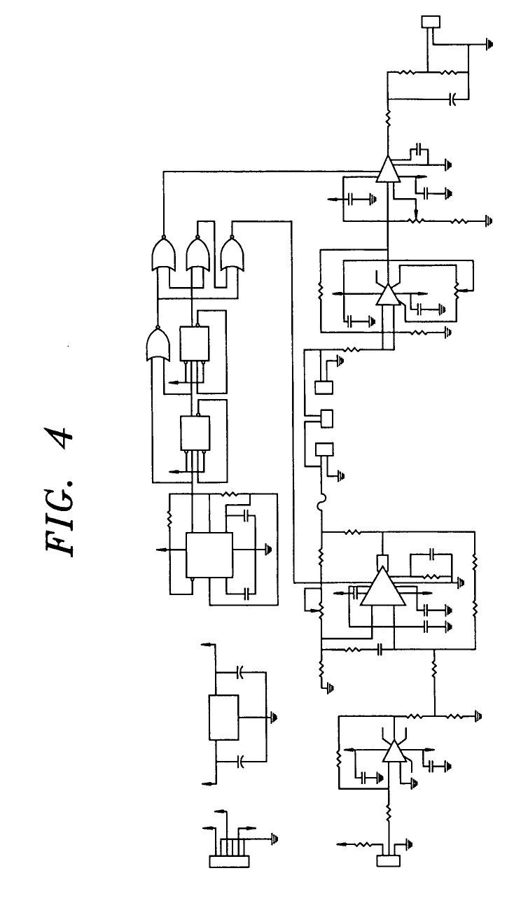

FIG. 4 shows a schematic of the control circuitry of one embodiment of the invention.

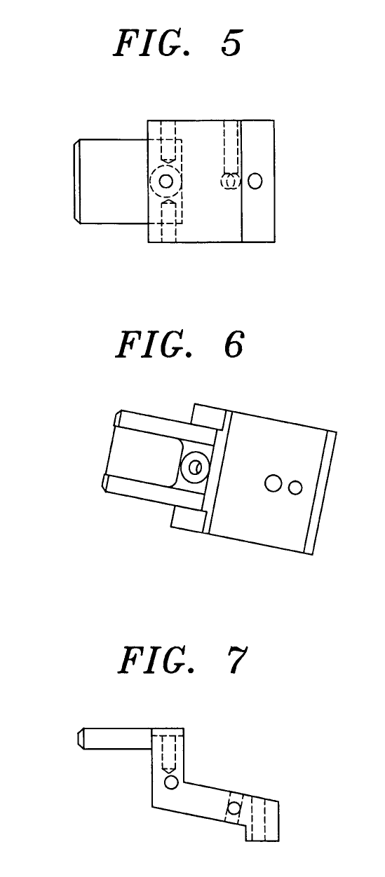

FIG. 5 shows an engineering diagram of a heater/temperature measuring device suitable for use in thermal desorption spectroscopy.

In other embodiments of the invention, the integral temperature measurement and resistance heater can be incorporated into the body of a conventional heater that is used for thin film deposition. The temperature can be monitored at the center of the platen. Alternative configurations enable measurement of the temperature distribution at any position over the radius.

The temperature range of the device is determined by the materials used. The methods of the present invention can be used with any resistance heater/thermocouple material, but must be compatible with the environment and the required temperature range. For example, Pt/PtRh thermocouples have an upper limit of about 1300 degrees Celsius in air. Alternatively, W/W/Re thermocouples cannot be used in air, but can operate at temperatures greater than 2000 degrees Celsius in high vacuum.

In some embodiments of the invention, there may be a large amount of power dissipation in the unit, making air circulation important to prevent the unit from overheating. Cooling vents are useful features, and should not be blocked.

The devices of the present invention may optionally be protected against polarity reversal of the input leads, improper sequencing, and excessive voltage input.

The accuracy of the thermocouple reading can be affected by dissimilar junctions between the test article and the electronics and their temperature gradients. In preferred embodiments, temperature is determined through a non-linear conversion function obtained via calibration runs in the actual operating environment.

The devices of the present invention are useful in a wide range of industrial and research applications. They may be particularly suitable for any operation requiring both heating and temperature measurement wherein space or costs are at a premium. One such example is in machinery for injection molding, where it is critical to know the temperature at the exit aperture. A system providing the capability of measuring temperature in multiple locations is contemplated by the methods and devices of the present invention.

### EXAMPLES

The present invention may be better understood with reference to the following examples. These examples are intended to be representative of specific embodiments of the invention, and are not intended as limiting the scope of the invention.

A prototype heater/thermocouple was built in accordance with the circuit diagrams in FIGS. 4 and 5. The prototype device was used to record the following data points provided in Table 1 and Table 2. The column headings in Tables 1 and 2 are defined below.

The heading “Control Setting” refers to the value of a 10-turn pot on the front panel of the device. This corresponds to a 0-10V input range at the back panel connector between pins A (positive) and E (Ground).

The heading “Current” refers to the current read from the front panel of the prototype's power supply (HP6264B). The maximum current of 7.2 Å represents a peak current of about 200 Å.

The heading “K-type tc” refers to the temperature of the prototype device's K-type thermocouple that was tack-welded to the heater foil near the integral injunction, as read on a Fluke 52II thermometer.

The heading “Integral Thermocouple Tint”, when measured in mV, refers to Is the voltage output at the integral thermocouple as measured at the back panel connector between pins C (positive) and B (negative). To obtain the temperature values provided in Table 1 below, the above voltage measurements were converted to temperature using a standard computational algorithm that utilizes a six-step process to linearize a reading. Other comparable temperature calculators known in the art can also be used to make the mV to Temperature conversion.

The heading “Tint−Offset” refers to the vertical offset of 360° C. removed from the temperature data.

The heading “Tk−Tint” refers to the difference between the temperature given by the internal thermocouple (Integral Thermocouple Tint) and the actual temperature measured at the K-type thermocouple (K-type Tc).

The heading “Error” refers to the difference between the actual temperature measured at the K-type thermocouple (K-type Tc) and the calculated Tint−Offset temperature. When computed as a percentage, the temperature difference is divided by the Tint−Offset value.

The heading “Leakage Current” refers to the current applied by the power amplifier, as measured into a short, during the measurement period. This current causes an error in the voltage read from the thermocouple that will vary as the resistance of the various conductors varies with temperature.

The heading “Resistance” refers to an approximated calculation of the resistance. The resistance of the stainless steel components was measured at 0.075 ohms at room temperature, of which approximately 0.028 ohms was contributed by the platinum/rhodium elements. The temperature coefficient of platinum was used to approximate the resistance of this element at elevated temperatures. The resistance of the stainless steel elements was estimated by assuming the stainless steel was at approximately one fourth of the temperature of the platinum.

The “Voltage drop” is calculated by multiplying the Leakage Current times the Resistance.

The “Adjusted Tint” is calculated by subtracted the Voltage Drop from the actual voltage measured (i.e., Integral Thermocouple Tint). This value for the Adjusted Tint is converted to temperature as described for the Integral Thermocouple Tint above.

TABLE 1

| | | K- | Integral | | | | | |
|---|---|---|---|---|---|---|---|---|
| | | type | Thermocouple | | Tint - | Tk - | | |
| Control | Current | tc | Tint | | Offset | Tint | Error | Error |
| Setting | (Å) | (° C.) | (mV) | (° C.) | (° C.) | (° C.) | (° C.) | (%) |
| 0.0 | 0.50 | 28.9 | 2.41 | 315.3 | −40.9 | 286 | 69.8 | 241.5 |
| 0.5 | 1.00 | 36.5 | 2.70 | 344.5 | −11.7 | 308 | 48.2 | 132.1 |
| 1.0 | 1.50 | 51.8 | 3.03 | 377.0 | 20.8 | 325 | 31.0 | 59.9 |
| 1.5 | 2.00 | 71.0 | 3.40 | 412.7 | 56.5 | 342 | 14.5 | 20.4 |
| 2.0 | 2.45 | 94.8 | 3.72 | 443.2 | 87.0 | 348 | 7.8 | 8.2 |
| 2.5 | 2.85 | 123.6 | 4.10 | 478.7 | 122.5 | 355 | 1.1 | 0.9 |
| 3.0 | 3.25 | 151.7 | 4.40 | 506.4 | 150.2 | 355 | 1.5 | 1.0 |
| 3.5 | 3.60 | 185.2 | 4.80 | 542.7 | 186.5 | 358 | −1.3 | −0.7 |
| 4.0 | 3.95 | 212.8 | 5.14 | 573.2 | 217.0 | 360 | −4.2 | −2.0 |
| 4.5 | 4.05 | 249.0 | 5.57 | 611.2 | 255.0 | 362 | −6.0 | −2.4 |
| 5.0 | 4.50 | 287.0 | 6.02 | 650.3 | 294.1 | 363 | −7.1 | −2.5 |
| 5.5 | 4.50 | 326.5 | 6.54 | 694.8 | 338.6 | 368 | −12.1 | −3.7 |
| 6.0 | 4.80 | 372.0 | 7.15 | 745.9 | 389.7 | 374 | −17.7 | −4.8 |
| 6.5 | 5.10 | 410.0 | 7.79 | 796.4 | 442.2 | 388 | −32.2 | −7.9 |
| 7.0 | 5.60 | 452.0 | 8.31 | 840.4 | 484.2 | 388 | −32.2 | −7.1 |
| 7.5 | 5.90 | 501.0 | 8.82 | 880.9 | 524.7 | 380 | −23.7 | −4.7 |
| 8.0 | 6.20 | 543.3 | 9.32 | 919.9 | 563.7 | 377 | −20.4 | −3.8 |
| 8.5 | 6.40 | 591.3 | 9.93 | 966.9 | 610.7 | 376 | −19.4 | −3.3 |
| 9.0 | 6.80 | 634.2 | 10.40 | 1002.6 | 646.4 | 368 | −12.2 | −1.9 |
| 9.5 | 7.00 | 678.0 | 10.70 | 1025.2 | 669.0 | 347 | 9.0 | 1.3 |
| 10.0 | 7.20 | 734.0 | 11.50 | 1064.7 | 728.5 | 351 | 5.5 | 0.7 |

TABLE 2

| | | | Leakage | | Voltage | Adjusted | Adjusted |
|---|---|---|---|---|---|---|---|
| Control | Current | K-type tc | Current | Resistance | Drop | Tint | Tint |
| Setting | (Å) | (° C.) | (mA) | (ohms) | (mV) | (mV) | (° C.) |
| 0.0 | 0.50 | 28.9 | 24.4 | 0.076 | 1.86 | 0.55 | 107.1 |
| 0.5 | 1.00 | 36.5 | 26.8 | 0.077 | 2.07 | 0.63 | 117.5 |
| 1.0 | 1.50 | 51.8 | 29.0 | 0.079 | 2.30 | 0.73 | 132.7 |
| 1.5 | 2.00 | 71.0 | 31.0 | 0.082 | 2.55 | 0.85 | 151.2 |
| 2.0 | 2.45 | 94.8 | 32.7 | 0.085 | 2.79 | 0.93 | 163.2 |
| 2.5 | 2.85 | 123.6 | 34.0 | 0.089 | 3.04 | 1.06 | 183.1 |
| 3.0 | 3.25 | 151.7 | 35.0 | 0.093 | 3.27 | 1.13 | 195.7 |
| 3.5 | 3.60 | 185.2 | 35.4 | 0.098 | 3.47 | 1.33 | 222.5 |
| 4.0 | 3.95 | 212.8 | 36.1 | 0.102 | 3.68 | 1.46 | 242.2 |
| 4.5 | 4.05 | 249.0 | 36.5 | 0.107 | 3.90 | 1.67 | 268.8 |
| 5.0 | 4.50 | 287.0 | 37.0 | 0.112 | 4.15 | 1.87 | 294.8 |
| 5.5 | 4.50 | 326.5 | 37.4 | 0.118 | 4.41 | 2.13 | 328.5 |
| 6.0 | 4.80 | 372.0 | 37.6 | 0.124 | 4.67 | 2.48 | 369.2 |
| 6.5 | 5.10 | 410.0 | 38.0 | 0.129 | 4.92 | 2.87 | 411.8 |
| 7.0 | 5.60 | 452.0 | 38.2 | 0.135 | 5.17 | 3.14 | 443.2 |
| 7.5 | 5.90 | 501.0 | 38.6 | 0.142 | 5.49 | 3.33 | 468.5 |
| 8.0 | 6.20 | 543.3 | 38.8 | 0.148 | 5.75 | 3.57 | 493.6 |
| 8.5 | 6.40 | 591.3 | 39.1 | 0.155 | 6.05 | 3.88 | 531.0 |
| 9.0 | 6.80 | 634.2 | 39.2 | 0.161 | 6.30 | 4.10 | 556.2 |
| 9.5 | 7.00 | 678.0 | 39.5 | 0.167 | 6.59 | 4.11 | 562.5 |
| 10.0 | 7.20 | 734.0 | 39.7 | 0.175 | 6.94 | 4.56 | 610.3 |

Although the foregoing invention has been described in some detail by way of illustration and example for purposes of clarity of understanding, it will be obvious that certain changes and modifications may be practiced within the scope of the representative embodiments of these concepts presented below.

We claim:

1. A resistance heating device comprising an integrated temperature measuring device, wherein said heating device includes a thermocouple wire as a lead.

2. The device of claim 1, wherein temperature is measured during the power off portion of an alternating cycle, and heat is applied during the power on portion of said alternating cycle.

3. The device of claim 2, wherein said device comprises an injection mold gun.

4. The device of claim 2, wherein said device comprises a sample holder for temperature desorption spectroscopy.

5. A method for providing both resistance heating and temperature measurement capabilities within a single integrated device, comprising applying an alternating cycle to said device, wherein temperature is measured during the portion of said alternating cycle when power is off, and heat is applied during the portion of said alternating cycle when power is on.

6. The method of claim 5, wherein said alternating cycle comprises a square wave.

7. The method of claim 5, wherein said device comprises an injection mold gun.

8. The method of claim 5, wherein said device comprises a sample holder for temperature desorption spectroscopy.
